(19) United States
(12) Patent Application Publication
(10) Pub. No.: US 2012/0161691 A1
(43) Pub. Date: Jun. 28, 2012

(54) Solar Powered Air Conditioner

(76) Inventor: Ramon E. Debesa, Hialeah, FL (US)

(21) Appl. No.: 13/048,420

(22) Filed: Mar. 15, 2011

Related U.S. Application Data
(63) Continuation of application No. 12/978,290, filed on Dec. 23, 2010.

(51) Int. Cl. H02J 7/35

(52) U.S. Cl. 320/101

(57) ABSTRACT

A solar powered air conditioner comprised of at least one solar panel, a first charge controller connected to the solar panel, a twelve Volt DC rechargeable battery connected to the charge controller, an inverter, that converts the DC voltage created by the twelve Volt rechargeable battery to AC voltage, connected to the twelve volt DC rechargeable battery, a battery charger that receives the AC voltage from the inverter and converts the AC voltage to DC voltage, a charge controller connected to the battery charger, a second rechargeable battery connected to the charge controller, a contactor connected to the second rechargeable battery and to a thermostat, a DC powered motor connected to the contactor, and an air conditioning system, the air conditioning system having an air compressor and an air conditioning motor, the air compressor connects to the DC powered motor via a belt, and the air conditioner motor connects to the contactor.

The present invention relates to an energy saving solar powered air conditioner. The present invention is a continuation in part of my application Ser. No. 12,978,290 filed on Dec. 23, 2010, entitled “Solar Powered Air Conditioner,” currently pending. The application is incorporated herein by this reference.

### BACKGROUND

The inventor of the present invention is an air conditioning technician that decided to reduce his electric bill by developing an air conditioner that would be solely dependent on solar power. After developing the air conditioner, the inventor realized that most home owners would install a solar dependent air conditioner in their homes if the cost of installation was reasonable.

Using a cost to benefit analysis, he understood that for most people to purchase a solar dependent air conditioner that the solar powered air conditioner had to be economical to manufacture and install. He further realized that most people would not change their air conditioners if their existing air conditioners were functional and there was no immediate financial return for changing to a solar powered air conditioner. By changing to a solar powered air conditioner, any person choosing to change to solar power would derive benefits immediately.

By providing the solar air conditioner of the present invention, the inventor knew that he would also be helping the environment, for less fossil fuels would be consumed to cool homes.

U.S. Pat. No. 6,880,553, Liu et al., discloses a solar air-conditioning system that is not similar to the present invention, yet it discloses drawbacks of using existing systems used to power or cool homes. The present invention is solely directed to providing consumers with an economical solar powered air conditioner that would allow most homeowners to switch to a solar power cooling system.

For the foregoing reasons, there is a need for a solar powered air conditioner that will be economical to manufacture, that will reduce the consumption of fossil fuels, and that will be solar powered.

### SUMMARY

The present invention is directed to a solar powered air conditioner that is economical to manufacture, that reduces the consumption of fossil fuels, and that is solar powered.

The solar powered air conditioner of the present invention comprises of at least one solar panel that generates at least 15 Watts of energy and that delivers at least 12 DC voltage, a first charge controller connected to the solar panel, a twelve Volt DC rechargeable battery connected to the charge controller; an inverter, that converts the DC voltage created by the twelve volt rechargeable battery to at least 110 AC voltage, connected to the twelve Volt DC rechargeable battery, a battery charger that receives the AC voltage from the inverter and converts the AC voltage to at least 6 to no more than 180 DC voltage, a charge controller connected to the battery charger, a second rechargeable battery connected to the charge controller, the second rechargeable battery is of at least 6 to no more than 180 DC Voltage, a contactor connected to the rechargeable battery and to a thermostat, a DC powered motor being of at least 6 to more than 180 DC voltage that can generate at least one horsepower of energy connected to the contactor, and an air conditioning system, the air conditioning system having an air compressor and an air conditioning motor being of at least 6 to more than 180 DC voltage, the air compressor connects to the DC powered motor via a belt, and the air conditioner motor connects to the contactor.

The present invention is a standalone air conditioner that does not require any outside source of electricity besides the solar panels.

An object of the present invention is to provide an air conditioner that can be solar powered.

Another object of the present invention is to provide a solar powered air conditioner that will be inexpensive to manufacture.

Yet another object of the present invention is to provide a solar powered air conditioner that will encourage consumers to purchase it.

A further object of the present invention is to provide an air conditioner that will reduce the consumption of fossil fuels.

### DRAWINGS

These and other features, aspects, and advantages of the present invention will become better understood with regard to the following description, appended claims, and drawings where:

FIG. 1 is a flow chart showing the solar powered air conditioner of the present invention.

### DESCRIPTION

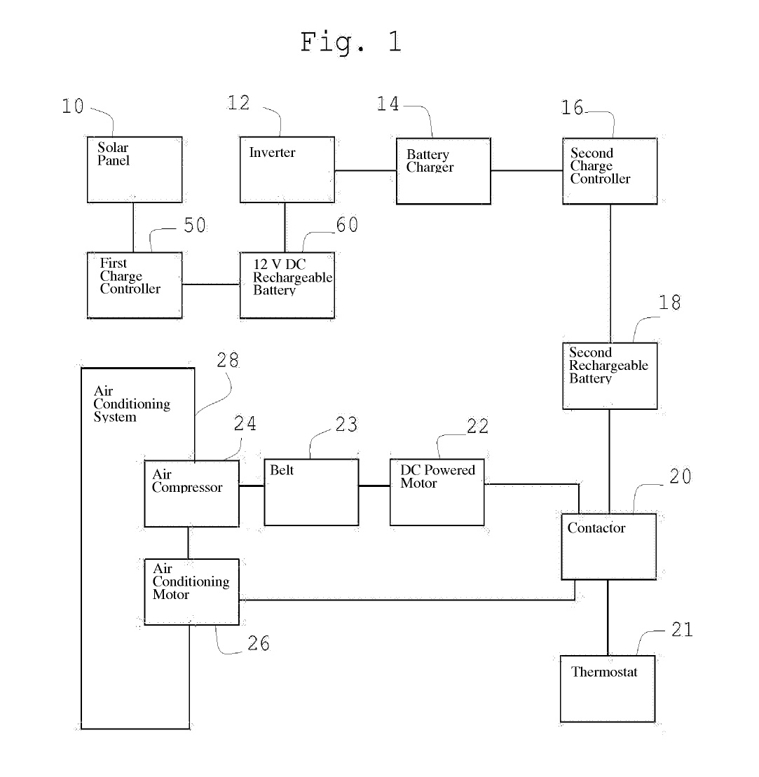

As seen in FIG. 1, a solar powered air conditioner comprises of at least one solar panel 10 that generates at least 15 Watts of energy and that delivers at least 12 DC voltage, a first charge controller 50 connected to the solar panel 10, a twelve Volt DC rechargeable battery 60 connected to the charge controller 50, an inverter 12, that converts the DC voltage from the twelve Volt DC battery 60 to at least 110 AC voltage, connected to the twelve Volt DC rechargeable battery 60, a battery charger 14 that receives the AC voltage from the inverter 12 and converts the AC voltage to at least 6 to no more than 180 DC voltage, a second charge controller 16 connected to the battery charger 14, a second rechargeable battery 18 connected to the charge controller 16, the second rechargeable battery 18 is of at least 6 to no more than 180 DC voltage, a contactor 20 connected to the second rechargeable battery 18 and to a thermostat 21, a DC powered motor 22 being of at least 6 to no more than 180 DC voltage that can generate at least one horsepower of energy connected to the contactor 20, and an air conditioning system 28, the air conditioning system 28 having an air compressor 24 and an air conditioner motor 26 being of at least 6 to more than 180 DC voltage, the air compressor 24 of the air conditioning system 28 connects to the DC powered motor 22 via a belt 23, and the air conditioner motor 26 connects to the contactor 20.

In a preferred embodiment, the solar powered air conditioner has the following specifications: the solar panel generates at least 15 Watts and delivers a 12 DC voltage; the inverter converts the DC voltage to a 110 AC voltage; the battery charger converts the AC voltage to a 36 DC voltage; the second rechargeable battery is a 36 DC voltage battery; and the DC powered motor and the air conditioner motor are 36 DC voltage motors.

The connections of the present invention are made using standard electrical wires (not numbered in FIG. 1).

In another embodiment of the present invention, the second rechargeable battery is a battery bank of at least six 6 DC voltage batteries (not shown in FIG. 1) connected in series.

An advantage of the present invention is that it provides an air conditioner that can be solar powered.

Another advantage of the present invention is that it provides a solar powered air conditioner that is inexpensive to manufacture.

Yet another advantage of the present invention is that it provides a solar powered air conditioner that encourages consumers to purchase it.

A further advantage of the present invention is that it provides an air conditioner that reduces the consumption of fossil fuels.

Although the present invention has been described in considerable detail in reference to preferred versions, other versions are possible. Therefore, the spirit and scope of the appended claims should not be limited to the description of the preferred versions contained herein.

1. A solar powered air conditioner comprising of:
at least one solar panel that generates at least 15 Watts of energy and that delivers a 12 DC voltage;
a first charge controller connected to the solar panel using electrical wires;
a first rechargeable battery, the first rechargeable battery is a twelve Volt DC rechargeable battery connected to the first charge controller using electrical wires;
an inverter, that converts the DC voltage from the twelve Volt DC battery to a 110 AC voltage, connected to the twelve Volt DC rechargeable battery using electrical wires;
a battery charger that receives the AC voltage from the inverter and converts the AC voltage to a 36 DC voltage;
a second charge controller connected to the battery charger using electrical wires;
a second rechargeable battery connected to the second charge controller using electrical wires, the second rechargeable battery is a bank of six 6 DC voltage batteries connected in series;
a contactor connected to the second rechargeable battery and to a thermostat using electrical wires;
a DC powered motor being a 36 DC voltage motor, that can generate at least one horsepower of energy, connected to the contactor using electrical wires; and
an air conditioning system, the air conditioning system comprising:
an air compressor, the air compressor connects to the DC powered motor via a belt; and
an air conditioning motor being a 36 DC voltage motor, the air conditioner motor connects to the contactor using electrical wires.

2. (canceled)

3. (canceled)

4. (canceled)

5. (canceled)

6. (canceled)

7. (canceled)

8. (canceled)
